(19) United States
(12) Patent Application Publication
(10) Pub. No.: US 2004/0074472 A1
(43) Pub. Date: Apr. 22, 2004

(54) Spray collision nozzle for direct injection engines

(76) Inventors: Martin Wirth, Remscheid (DE); Ulrich Kramer, Bergisch Gladbach (DE); Diana Zimmermann, KoeIn (DE); Karl Walder, Wipperfuerth (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/666,321

(22) Filed: Sep. 18, 2003

(30) Foreign Application Priority Data
Oct. 22, 2002 (EP) 02102472.4

(51) Int. Cl. F02B 3/00

(52) U.S. Cl. 123/305; 123/298; 123/294; 239/543

(57) ABSTRACT

The invention relates to a fuel injector (1) for an internal combustion engine, in which the fuel jets (4a, 4b) emerging from two orifices (3a, 3b) collide prior to traveling to the ignition device. In this way, it is possible to produce an ignitable fuel mist in the vicinity of the ignition device, without the ignition device being directly struck by liquid fuel.

### FIELD OF THE INVENTION

The invention relates to a fuel injector for the direct injection of fuel into the combustion chamber of an internal combustion engine, comprising at least two orifices for delivering fuel. Furthermore, the invention relates to an internal combustion engine with direct injection, comprising a combustion chamber, in which an ignition device and a fuel injector with at least two orifices for fuel are arranged. Finally, the invention relates to a method for the direct injection of fuel into the combustion chambers of an internal combustion engine, in which fuel jets are aimed at an ignition device.

### BACKGROUND OF THE INVENTION

In spark ignition internal combustion engines (Otto engines), the direct injection of fuel into the combustion chambers or cylinders is becoming increasingly widespread because of the positive properties associated with it. Various methods are known for distributing the injected fuel in the combustion chamber, such as “wall-guided” and “air jet-guided” direct injection, for example. What is known as “jet-guided” direct injection has a particularly high fuel utilization potential; in this method the path of the fuel in the combustion chamber is not governed by the combustion chamber walls or an accompanying air jet, but instead by the momentum of the fuel after it leaves the injection nozzle. Jet-guided direct injection has the problem, however, that the fuel jet is aimed directly in the direction of the spark plug to ensure ignition of the fuel/air mixture. This leads to deposition of liquid fuel on the spark plug. Deposits forming on the spark plug electrodes may impair or prevent subsequent ignition.

To solve this problem, injectors with a plurality of orifices have been proposed, in which all orifices are aimed into the vicinity of the spark plug, but not, however, directly onto the electrodes. In this way, it is possible to produce a cloud of fuel without wetting the electrode. However, a disadvantage of these injectors is that the numerous outlet openings of small diameter may become blocked relatively quickly with carbon deposits, so that they no longer function correctly even after a short operating time of the engine. These problems can be reduced by reducing the number of outlet openings in the fuel injector to typically five to seven with a correspondingly larger diameter, but this in turn impairs the desired production of a fuel mist in the vicinity of the electrode.

Furthermore, U.S. Pat. No. 4,699,323 discloses a fuel injector for the injection of fuel into the intake manifold of an internal combustion engine, said fuel injector having a plurality of orifices which are aligned in such a way that they direct the emerging fuel jets in two separate directions corresponding to two different inlet valves of a cylinder. In this case, a partial collision can occur between the fuel jets emerging from two different orifices.

### SUMMARY OF THE INVENTION

The fuel injector according to the invention provides for the direct injection of fuel into the combustion chamber of an internal combustion chamber by a plurality of orifices. The fuel injector is distinguished by the fact that all its orifices are aligned in such a way that the fuel jets collide with one another.

According to one aspect of the invention, the collision between the fuel jets is complete, which means that there is no fuel particle path from a fuel jet which would not intersect the movement path of a fuel particle from another fuel jet. An advantage of the invention is that each fuel particle or fuel droplet therefore collides after it has entered the combustion chamber with a fuel particle/fuel droplet from another orifice. The collision causes an abrupt change in the direction of the fuel particles, with some canceling of momentum, and the fuel is distributed and atomized at the site of the collision. Yet another advantage of an injector according to the invention is that it is possible to transport the fuel, initially jet-guided, over a relatively long distance for it to be dispersed into a finely distributed, almost stationary, mist at the point where two fuel jets collide.

Furthermore, the invention relates to an internal combustion engine with direct injection and having a combustion chamber, in which an ignition device (for example, a spark plug) and at least one fuel injector as well as at least two orifices for fuel are arranged. The internal combustion engine is distinguished by the fact that the orifices of the fuel injector or fuel injectors are arranged and configured in such a way that fuel jets exiting from the orifices in the direction of the ignition device collide with one another before traveling to the ignition device—that is to say, the collision occurs in between the fuel injector and the ignition device. In one embodiment, the fuel injector can be of the type mentioned above, in which the jets from all the orifices collide with one another. Alternatively, one the jets aimed at the ignition device collide, while fuel jets emerging in other directions can optionally freely continue on their paths, i.e. without collisions.

The internal combustion engine described has the advantage that the fuel is transported, in a jet-guided manner, into the vicinity of the ignition device, where further movement is then interrupted by the collision which occurs and the fuel is atomized. In this way, it is possible to produce an ignitable fuel/air mixture at the ignition device, without the ignition device being struck directly by liquid fuel. Consequently, at most slight deposits are formed on the ignition device, so that the functioning of the latter is ensured for long periods of time.

The above-described fuel injector or the fuel injectors of the abovedescribed internal combustion engine can be developed and configured in various ways, as explained in the following text.

For example, the orifices can be configured or aligned in such a way that their axes extend into the combustion chamber in such a way that they do not intersect the ignition device. The fuel jets leaving the orifices would therefore not directly strike the ignition device even if they did not collide with other fuel jets prior to traveling the distance of the ignition device. An advantage is that even if an orifice fails (e.g., as a result of blockage), the ignition device is not wetted directly with liquid fuel by the remaining fuel jet, and that, furthermore, fuel particles whose momentum has been influenced little during the collision with another fuel jet do not travel directly onto the ignition device along their continued path.

In a preferred embodiment, the fuel injector has precisely two orifices. The desired collision of various fuel jets can be brought about with two orifices, without the cross-section of the individual orifices, which is determined by the total amount of fuel to be injected, being too small. The risk of the orifices becoming blocked as a result of deposits of combustion residues is therefore minimized.

According to another embodiment, the orifices have elongated outlet openings. For example, the outlet openings can be rectangular, the longer side of the rectangle being longer than the shorter side by a multiple. By the elongated cross-sectional shape, widely fanned fuel jets can be produced, so that the fuel is already distributed in one dimension without rapid and compact transport in the direction of the ignition device being impaired thereby.

In the case of elongated cross-sectional shape of the orifices, the longitudinal axes of the cross sections of the orifices preferably lie parallel to one another. When the associated fuel jets strike one another, there is thus a collision which takes place over the entire width of the jets with a large tolerance with respect to deviations of the jet alignment.

Furthermore, it is preferred that the orifices of the fuel injector are configured and arranged symmetrically with respect to a central plane or plane of symmetry. This results in no side of the plane of symmetry being preferred by the construction of the fuel injector, so that the cloud of fuel produced when the fuel jets strike one another is also substantially symmetrical. Furthermore, the momentum components, lying perpendicular to the plane of symmetry, of the fuel particles substantially cancel one another out, as they are of equal magnitude but aligned in opposite directions.

According to one embodiment, the fuel injectors have a valve element which can be moved linearly in the direction of the structural longitudinal axis of the fuel injectors, it being possible, by the movement of said movable valve element, to control the magnitude of the fuel flow, or to interrupt said fuel flow. According to a first embodiment, the orifices of the fuel injectors can be aligned substantially perpendicularly to said longitudinal axis of the fuel injector (i.e. to the movement axis of the valve element). A fuel injector of this type can be inserted into the combustion chamber with its longitudinal axis approximately parallel to the ignition device, the fuel jets emerging laterally from the fuel injector. According to a second embodiment, the orifices are aligned substantially in the direction of the longitudinal axis of the fuel injector. The fuel jets extend substantially in the direction of the extended longitudinal axis of the fuel injector. This construction proves to be advantageous when the fuel injector is installed in the combustion chamber in a position in which its longitudinal axis is aligned approximately toward the ignition device.

Furthermore, the invention relates to a method for the direct injection of fuel into the combustion chamber of an internal combustion engine, fuel jets being aimed at an ignition device in the combustion chamber. The method is distinguished by the fact that said fuel jets, which move in the direction of the ignition device, collide with one another in front of the ignition device. As has already been explained in the above text, a collision of this type has the advantage of producing a virtually stationary fuel mist in the region of the ignition device, without wetting the ignition device. Here, the method affords the possibility of fuel jets not aimed toward the ignition device being able to travel along their path without colliding with other fuel jets. Furthermore, it is possible to develop the method in accordance with the features of the abovedescribed fuel injectors and by using the latter.

### BRIEF DESCRIPTION OF THE DRAWINGS

In the following text, the invention will be explained in greater detail by way of example, using the figures, in which:

FIG. 1 shows a lateral sectional view through the head of a combustion chamber having a fuel injector in accordance with a first embodiment of the invention;

FIG. 2 shows a section through the fuel injector from FIG. 1 along the line II-II;

FIG. 3 shows a view of the fuel injector from FIG. 2 from the direction III;

FIG. 4 shows a lateral sectional view through the head of a combustion chamber having a fuel injector in accordance with a second embodiment of the invention;

FIG. 5 shows a section through the fuel injector from FIG. 4 along the line V-V from FIG. 6; and

FIG. 6 shows a view of the fuel injector from FIG. 4 from the direction VI.

### DETAILED DESCRIPTION

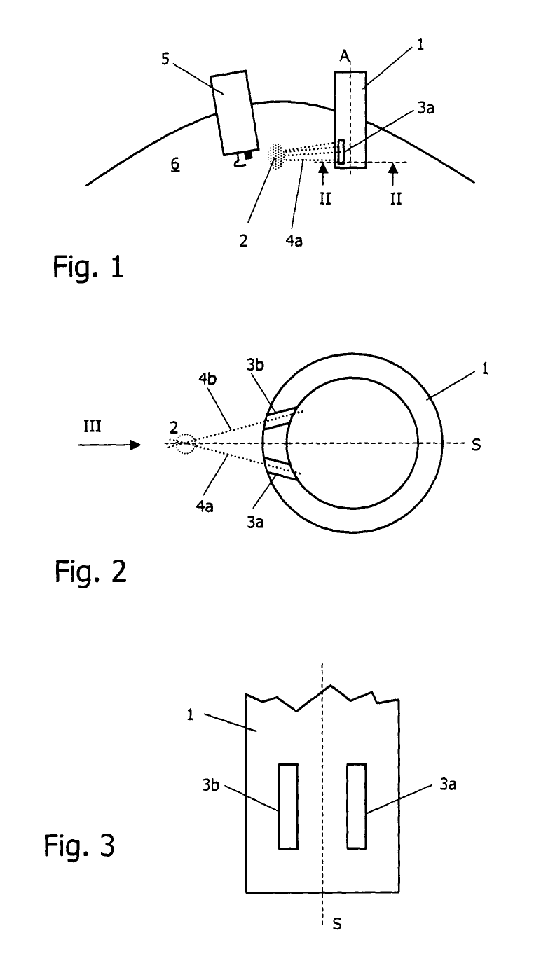

FIGS. 1 to 3 show a first embodiment of a fuel injector 1 according to the invention for the direct injection of fuel into combustion chamber 6 of an internal combustion engine. Fuel injector 1 is arranged with its longitudinal axis A substantially perpendicular to the roof of combustion chamber 6 and substantially parallel to a spark plug 5.

From the section through fuel injector 1 along a line II-II (FIG. 2) and from a side view of fuel injector 1 from direction III (FIG. 3), fuel injector 1 has, at its sides, two orifices 3a, 3b with an elongated rectangular cross section. The elongated shape of the orifices 3a, 3b has the fuel jets emerging therefrom spread out in the manner of a fan. Furthermore, orifices 3a, 3b are configured symmetrically with respect to a central plane S running through the fuel injector.

The special feature of orifices 3a, 3b consists in that their axes of extension converge outside fuel injector 1, so that fuel jets 4a, 4b emerging from orifices 3a, 3b strike one another at a collision point 2 or, to be more precise, along a collision line 2 (perpendicular to the plane of the drawing in FIG. 2). Collision line 2 is positioned, in this example, in the vicinity of the electrodes of spark plug 5. The consequence of the fuel jets 4a, 4b colliding is that, firstly, the onward movement of the fuel is impeded and, secondly, a fine fuel mist is formed at the site of the collision. In this way, an ignitable fuel/air mixture is produced in the immediate vicinity of the electrodes of spark plug 5, without the electrodes being struck directly by liquid fuel and therefore reducing risk of their function being impaired by deposits.

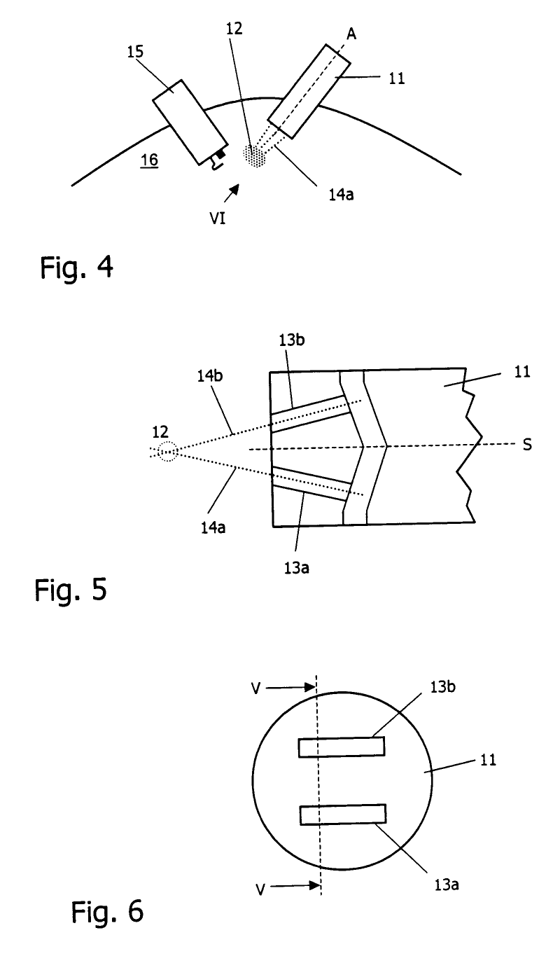

FIGS. 4 to 6 show a second embodiment of a fuel injector 11 for direct injection into a combustion chamber 16. In FIGS. 1 to 6, identical or similar parts are provided with designations whose last digits coincide.

The difference from the embodiment according to FIGS. 1 to 3 is that fuel injector 11 is arranged with its axis A substantially perpendicular to spark plug 15. So that fuel jets 14a, 14b emerging from fuel injector 11 move in the direction of ignition device 15, orifices 13a, 13b of fuel injector 11 travel to a direction not coincident with ignition device 15, shown in FIG. 6. The orifices have an elongated rectangular cross section.

It can be seen in FIG. 5, in a sectional view through fuel injector 11 along the line V-V (FIG. 6), that orifices 13a, 13b are symmetrical with respect to a central plane S and extend so that their axes of extension meet at a collision point or on a collision line 12. Collision line 12 is positioned in the vicinity of the electrodes of the ignition device 15, so that a finely atomized, ignitable fuel/air mixture is produced there, without the electrodes themselves being struck directly.

The designs shown by way of example can be modified in various ways. In particular, the fuel injectors can have more than two orifices, or a plurality of fuel injectors having fuel jets aimed at one another can be provided for each combustion chamber.

We claim:

1. A fuel injector (1, 11) for the direct injection of fuel into the combustion chamber (6, 16) of an internal combustion engine, comprising:
at least two orifices (3a, 3b, 13a, 13b) for supplying fuel wherein the orifices (3a, 3b, 13a, 13b) are aligned in such a way that fuel jets (4a, 4b, 14a, 14b) emerging from said orifices collide with one another.

2. The fuel injector of claim 1 wherein said fuel injector (1, 11) has two orifices (3a, 3b, 13a, 13b).

3. The fuel injector (1, 11) of claim 1, further comprising: a valve element adapted to move linearly in the direction of its longitudinal axis (A) wherein said orifices (3a, 3b) are aligned substantially perpendicularly to said longitudinal axis.

4. The fuel injector (1, 11) of claim 1, further comprising: a valve element adapted to move in the direction of its longitudinal axis (A) wherein said orifices (3a, 3b, 13a, 13b) are aligned substantially in the direction of said longitudinal axis.

5. The fuel injector of claim 1 wherein said orifices (3a, 3b, 13a, 13b) are elongated.

6. The fuel injector of claim 5 wherein longitudinal axes of the cross sections of the orifices (3a, 3b, 13a, 13b) lie substantially parallel to one another.

7. The injector of claim 2 wherein said orifices (3a, 3b, 13a, 13b) are symmetrical with respect to a plane of symmetry (S).

8. An internal combustion engine with direct fuel injection, comprising:
a combustion chamber (6, 16), in which an ignition device (5, 15) and at least one fuel injector (1, 11) are arranged wherein said fuel injection has at least two orifices (3a, 3b, 13a, 13b) for delivering fuel, said orifices (3a, 3b, 13a, 13b) being arranged in such a way that fuel jets (4a, 4b, 14a, 14b) emanating from said orifices toward said ignition device (5, 15) collide with one another before reaching said ignition device.

9. The internal combustion engine of claim 8 wherein the axes of extension of the orifices (3a, 3b, 13a, 13b) do not intersect said ignition device (5, 15).

10. The internal combustion engine of claim 8 wherein said fuel injector (1, 11) has two orifices (3a, 3b, 13a, 13b).

11. The internal combustion engine of claim 8 wherein said orifices (3a, 3b, 13a, 13b) are elongated.

12. The internal combustion engine of claim 11 wherein longitudinal axes of the cross sections of the orifices (3a, 3b, 13a, 13b) lie substantially parallel to one another.

13. The internal combustion engine of claim 8 wherein said orifices (3a, 3b, 13a, 13b) are symmetrical with respect to a plane of symmetry (S).

14. The internal combustion engine of claim 8 wherein said fuel injector (1, 11) has a valve element adapted to move linearly in the direction of its longitudinal axis (A), and said orifices (3a, 3b, 13a, 13b) are aligned substantially perpendicularly to said longitudinal axis.

15. The internal combustion engine of claim 8 wherein said fuel injector (1, 11) has a valve element adapted to move in the direction of its longitudinal axis (A), and said orifices (3a, 3b, 13a, 13b) are aligned substantially in the direction of said longitudinal axis.
